(19) United States
(12) Patent Application Publication
(10) Pub. No.: US 2018/0258269 A1
(43) Pub. Date: Sep. 13, 2018

(54) POLYPROPYLENE RESIN COMPOSITION AND MOLDED PRODUCT THEREOF

(71) Applicants: HYUNDAI MOTOR COMPANY, Seoul (KR); KIA MOTORS CORPORATION, Seoul (KR); LG Hausys, Ltd., Seoul (KR)

(72) Inventors: Hyun Gyung KIM, Hwaseong-si (KR); Hee Joon LEE, Seoul (KR); Yoon Hwan LEE, Seoul (KR); Jae Gon LIM, Seoul (KR); Ki Hyun SUNG, Ulsan (KR); Chun Ho PARK, Cheongju-si (KR)

(21) Appl. No.: 15/870,528

(22) Filed: Jan. 12, 2018

(30) Foreign Application Priority Data
Mar. 10, 2017 (KR) 10-2017-0030706

(51) Int. Cl. C08L 23/12; C08L 23/14; C08L 23/08; C08L 25/08; C08K 3/013; C08K 3/34; C08K 9/04

(52) U.S. Cl. CPC C08L 23/12; C08L 23/14; C08L 23/0815; C08L 25/08; C08K 3/013; C08K 2201/003; C08K 9/04; C08L 2205/02; C08L 2207/04; C08L 2207/10; C08K 3/346

(57) ABSTRACT

The present disclosure provides a polypropylene resin composition including a base resin, a thermoplastic elastomer, and a modified inorganic filler.

### CROSS-REFERENCE TO RELATED APPLICATION

This application claims the benefit of priority to Korean Patent Application No. 10-2017-0030706, filed on Mar. 10, 2017 in the Korean Intellectual Property Office, the entire content of which is incorporated herein by reference.

### TECHNICAL FIELD

The present disclosure relates to a polypropylene resin composition and a molded product thereof.

### BACKGROUND

The reduction in weight of automobiles has recently become a more significant issue due to environmental regulations, an improvement in fuel efficiency, the next-generation automobile (electric vehicle, and the like), and the like. In the case of a bumper which has the highest weight among automobile plastic parts, the reduction in weight may be achieved by making the thickness of an injection object small to reduce the weight. However, when the thickness of the injection object is decreased, mechanical properties deteriorate as much as that, and accordingly, there problems may occur in that the assembling workability on automobile production lines and the stability in the case of an accident deteriorate. Therefore, in order to secure the stability in the case of an accident while lowering energy consumption required for injection molding, there is a need for developing a material, which has high fluidity and high rigidity for an ultra-thin film of a part.

The above information disclosed in this Background section is only for enhancement of understanding of the background of the disclosure and therefore it may contain information that does not form the prior art that is already known in this country to a person of ordinary skill in the art.

### SUMMARY OF THE DISCLOSURE

The present disclosure has been made in an effort to solve the above-described problems associated with prior art.

An exemplary embodiment of the present disclosure provides a polypropylene resin composition which may simultaneously impart excellent rigidity, impact resistance, and coating adhesion property while maintaining a low specific gravity.

In one aspect, the present disclosure provides a polypropylene resin composition including a base resin, a thermoplastic elastomer, and a modified inorganic filler.

In another aspect, the present disclosure provides a molded product including an injection object of the polypropylene resin composition.

The polypropylene resin composition may simultaneously impart excellent rigidity, impact resistance, and coating adhesion property even when applied to a molded product having a small thickness, while maintaining a low specific gravity.

Other aspects and embodiments of the disclosure are discussed infra.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The above and other features of the disclosure are discussed infra.

### DETAILED DESCRIPTION

Hereinafter reference will now be made in detail to various embodiments of the present disclosure, examples of which are described below. While the disclosure will be described in conjunction with exemplary embodiments, it will be understood that present description is not intended to limit the disclosure to those exemplary embodiments. On the contrary, the disclosure is intended to cover not only the exemplary embodiments, but also various alternatives, modifications, equivalents and other embodiments, which may be included within the spirit and scope of the invention as defined by the appended claims.

The benefits and features of the present disclosure, and the methods of achieving the benefits and features will become apparent with reference to Examples to be described below. However, the present disclosure is not limited to Examples to be disclosed below, but may be implemented in various other forms, and the present Examples are only provided for rendering the disclosure of the present disclosure complete and for fully representing the scope of the disclosure to a person with ordinary skill in the art to which the present disclosure pertains, and the present disclosure will be defined only by the scope of the claims.

In one aspect, the present disclosure provides a polypropylene resin composition including a base resin, a thermoplastic elastomer, and a modified inorganic filler. The polypropylene resin composition does not include an inorganic filler in a high content, and thus may maintain a low specific gravity, and may simultaneously impart excellent rigidity, impact resistance, and coating adhesion property even when a part having a large weight is molded with a small thickness.

The polypropylene resin composition includes a base resin, and the base resin may include one polypropylene resin selected from the group consisting of a propylene homopolymer, a copolymer of propylene and an α-olefin monomer having 2 and 4 to 20 carbon atoms, and a combination thereof.

Examples of the α-olefin monomer having 2 and 4 to 20 carbon atoms include, ethylene, 1-butene, 1-pentene, 1-hexene, 4-methylpentene, 1-heptene, 1-octene, 1-decene, and the like. Specifically, the copolymer of propylene and the α-olefin monomer having 2 and 4 to 20 carbon atoms may be an ethylene-propylene copolymer. Further, the copolymer of propylene and the α-olefin monomer having 2 and 4 to 20 carbon atoms may be a block copolymer or a random copolymer. In addition, the copolymer of the propylene and the α-olefin monomer having 2 and 4 to 20 carbon atoms may include a propylene repeating unit in an amount of about 50 wt % or more. Specifically, the copolymer of the propylene and the α-olefin monomer having 2 and 4 to 20 carbon atoms may include a propylene repeating unit in an amount of about 50 wt % or more and about 90 wt % or less. The copolymer includes propylene in a relatively high content, and thus may enhance the crystallinity of a polypropylene resin and may improve the rigidity of a resin composition including the polypropylene resin.

The base resin may have an isotactic pentad fraction of about 0.80 to about 0.99 measured by ¹³C-NMR method. The term ‘pentad fraction’ represents an abundance ratio of an isotactic chain in a pentad unit in a molecular chain, measured by using ¹³C-NMR, and means a fraction of propylene monomer units being present at the center of a chain in which 5 propylene monomer units are continuously meso-bonded. The polypropylene resin composition may impart excellent mechanical strength and impact resistance by including a propylene homopolymer having a pentad fraction within the range in the base resin. The base resin may have a melt index of about 20 g/10 min to about 100 g/10 min measured at a temperature of 230° C. and under a load of 2.16 kg in accordance with ASTM D1238. The polypropylene resin composition includes a base resin having a melt index within the range, and thus may impart improved moldability and appearance characteristics, and may simultaneously impart excellent mechanical properties. Specifically, when the melt index of the base resin is less than the range, the flowability of the resin deteriorates during an injection molding, and as a result, the processability may deteriorate, and when the melt index of the base resin is more than the range, the balance between rigidity and impact resistance of an injection object may deteriorate.

The polypropylene resin composition may include the base resin in an amount of about 50 wt % to about 80 wt %. When the content of the base resin is less than the range, the coating adhesion force may deteriorate, and when the content is more than the range, the flexural modulus, and the like may deteriorate.

The polypropylene resin composition includes a thermoplastic elastomer, and thus may impart excellent impact strength, heat resistance, and coating adhesion force, and may exhibit excellent injection moldability.

The thermoplastic elastomer may include one selected from the group consisting of an olefin copolymer of ethylene and an α-olefin having 3 to 12 carbon atoms, a styrene-based copolymer, and a combination thereof. The content of the α-olefin in the thermoplastic elastomer may be about 20 wt % to about 50 wt %.

The α-olefin having 3 to 12 carbon atoms may be one α-olefin compound selected from the group consisting of 1-propene, 1-butene, 1-pentene, 4-methyl-1-pentene, 1-hexene, 1-heptene, 1-octene, 1-decene, 1-undecene, 1-dodecene, and a combination thereof. For example, the olefin copolymer may be a random copolymer.

The styrene-based copolymer may be one copolymer selected from the group consisting of a styrene-ethylene copolymer, a styrene-butylene copolymer, a styrene-ethylene-propylene copolymer, a styrene-isoprene-styrene copolymer, a styrene-butylene-styrene copolymer, a styrene-ethylene-butylene-styrene copolymer, a styrene-ethylene-propylene-styrene copolymer, a styrene-ethylene-ethylene-propylene-styrene copolymer, and a combination thereof. For example, the styrene-based copolymer may be a block copolymer.

The polypropylene resin composition includes a thermoplastic elastomer having a viscosity which is equal to or more than that of the base resin, and thus may suppress an injection object from being morphologically elongated on the surface of a molded product which is an injection object of the polypropylene resin composition, and may impart excellent coating adhesion force.

The thermoplastic elastomer may have an intrinsic viscosity of about 2 dl/g to about 4 dl/g. When the intrinsic viscosity of the thermoplastic elastomer is less than the range, the coating adhesion force may deteriorate, and when the intrinsic viscosity is more than the range, mechanical properties such as impact strength may deteriorate.

The thermoplastic elastomer may be included in a content of about 24 parts by weight to about 44 parts by weight based on 100 parts by weight of the base resin. Specifically, when the content of the thermoplastic elastomer is less than the range, the impact strength may deteriorate, and when the content is more than the range, the ductility is reinforced, and as a result, mechanical properties such as flexural modulus may deteriorate, and accordingly, it may be difficult for the thermoplastic elastomer to be used as a part for an automobile.

The polypropylene resin composition includes a modified inorganic filler, and thus may prevent the inorganic fillers from aggregating, may improve adhesion of the resin by enhancing the compatibility with the resin, may impart improved dispersibility, and may impart excellent processability. Accordingly, the polypropylene resin composition may simultaneously impart excellent rigidity, impact resistance, and coating adhesion property without including the inorganic filler in a high content.

Specifically, the polypropylene resin composition may include an inorganic filler modified by being surface treated with an organic titanate-based coupling agent, an organic silane-based coupling agent, a modified polyolefin grafted with an unsaturated carboxylic acid or an anhydride thereof, fatty acid, a fatty acid metal salt, a fatty acid ester, and a combination thereof.

More specifically, the inorganic filler may be modified with a surface-treating agent such as a titanate-based coupling agent such as isopropyl triisostearoyl titanate, isopropyl bis(di-octylphosphite)titanate, and isopropyldodecylbenzene sulfonyl titanate; a silane-based coupling agent such as γ-glycidoxypropyltrimethoxysilane, β-(3,4-epoxycyclohexyl)ethyltrimethoxysilane, vinyltriethoxysilane, vinyltriethoxysilane, vinyl-tris(2-methoxyethoxy)silane, γ-methacryloxypropyltrimethoxysilane, γ-aminopropyltrimethoxysilane, N-β-(aminoethyl)-γ-aminopropyldimethoxysilane, γ-mercaptopropyltrimethoxysilane, and γ-chloropropyltrimethoxysilane; a maleic modified product being a modified polyolefin grafted with an unsaturated carboxylic anhydride such as maleinized polypropylene, maleinized polyethylene, and maleinized styrene-ethylene butene styrene; a saturated and/or unsaturated fatty acid such as lauric acid, stearic acid, behenic acid, montanic acid, and erucic acid; a fatty acid metal salt thereof, such as magnesium, calcium, lithium, zinc, and sodium; and an ester compound thereof.

For example, the polypropylene resin composition includes an inorganic filler modified with a silane-based coupling agent, and thus may further improve excellent rigidity, impact resistance, and coating adhesion property.

The inorganic filler may be modified, for example, by immersing the inorganic filler in about 0.01 wt % to about 1.00 wt % of an aqueous solution of the surface-treating agent, or a moisture dispersion liquid, and then performing a heat treatment at a temperature of about 140° C. to about 160° C. for about 1 hour to about 2 hours.

The polypropylene resin composition has excellent dispersibility by including an inorganic filler having an average diameter of about 0.1 μm to about 5 μm, and may impart improved mechanical rigidity such as excellent rigidity and impact resistance due to a large surface area. Specifically, when the average diameter of the inorganic filler is less than the range, the surface area is so large that there is a problem with compatibility of the inorganic filler with the base resin, the rigidity may be decreased, and an aggregation problem is likely to occur because it is difficult to finely disperse the inorganic filler. Further, when the average diameter of the inorganic filler is more than the range, the rigidity and impact strength deteriorate, so that when the inorganic filler is applied to a molded product having a small thickness, the molded product is broken, and as a result, physical properties are decreased, or the appearance may be deformed.

The inorganic filler may be one selected from the group consisting of talc, whisker, nano clay, and a combination thereof.

The inorganic filler may be included in a content of about 8 parts by weight to about 41 parts by weight based on 100 parts by weight of the base resin. Specifically, when the content of the inorganic filler is less than the range, flexural modulus and coating adhesion property may significantly deteriorate, and when the content is more than the range, weight reduction, processability, and appearance characteristics of a polypropylene resin composition may be decreased.

By appropriately mixing the base resin with the modified inorganic filler, the polypropylene resin composition may simultaneously impart excellent processability, high tensile strength, flexural modulus, and impact strength, and coating adhesion property even when applied to a molded product having a small thickness, while maintaining a low specific gravity.

The polypropylene resin composition may further include one additive selected from the group consisting of an antioxidant, a processing lubricant, a colorant, and a combination thereof.

An antioxidant may be one selected from the group consisting of a phenol-based antioxidant, a phosphite-based antioxidant, thiodipropionate, and a combination thereof.

A processing lubricant is included in a polypropylene resin composition, and thus has a characteristic of removing a halogen material included in the resin composition or enhancing the processability, and the processing lubricant may be one selected from the group consisting of calcium stearate, magnesium stearate, and a combination thereof.

In another aspect, the present disclosure provides a molded product including an injection object of the polypropylene resin composition. The molded product includes an injection object of the above-described polypropylene resin composition, and may have excellent processability and excellent mechanical properties, that is, high impact strength and flexural modulus and excellent coating adhesion property even when applied to a molded product having a small thickness, while maintaining a low specific gravity. The matters on the polypropylene resin composition are the same as those described above.

The molded product may be used for use of an automobile exterior material, such as a bumper, a side sill molding, a door trim spoiler, a side visor, a cowl vent grille, a radiator grille, a side molding, and an end panel garnish.

Specifically, the molded product has a small thickness, and thus may further reduce the weight and simultaneously have excellent mechanical rigidity, impact resistance, and excellent coating adhesion property. For example, the molded product may exhibit excellent mechanical strength and impact resistance even in a thickness of less than about 2.5 mm. The molded product may have a thickness of about 2.0 mm to about 2.4 mm. Accordingly, the molded product may be suitable for being used as an interior and exterior material for an automobile, such as a bumper.

The molded product may have a flexural modulus of about 2,500 MPa or more, for example, about 2,500 MPa to about 3,000 MPa, measured in accordance with ASTM D790.

The flexural modulus means a ratio of tensile strength and deformation within the elastic limit by applying a flexural load to a polymer. The molded product is manufactured from the above-described polypropylene resin composition, and when the molded product has a flexural modulus less than the range, the molded product cannot withstand external impact when applied to a bumper, and the like, which is a molded product having a thickness of about 2.4 mm or less, and thus may not be suitable as an automobile exterior material.

Hereinafter, specific examples of embodiments of the present disclosure will be described. However, the Examples described below are only provided for specifically exemplifying or explaining the present disclosure, and the present disclosure is not limited thereby.

### EXAMPLES

The following examples illustrate exemplary embodiments of the present disclosure and are not intended to limit the same.

### Example 1

A polypropylene resin composition including: a base resin being an ethylene-propylene block copolymer having a melt index of 100 g/10 min measured at a temperature of 230° C. and under a load of 2.16 kg in accordance with ASTM D1238; an ethylene-octene random copolymer having an intrinsic viscosity of 2.5 dl/g as a thermoplastic elastomer; and a modified inorganic filler including a talc having an average diameter of 1.0 μm, which was surface-treated with an organic silane-based coupling agent, and a whisker surface-treated with an organic silane-based coupling agent; was prepared.

At this time, the ethylene-propylene block copolymer, the ethylene-octene random copolymer, and the surface-modified talc and whisker were mixed at a ratio of about 62 wt % : 20 wt % : 12 wt % : 6 wt %.

The polypropylene resin composition was introduced into a main hopper in a twin-screw extruder (SM PLATEK, screw diameter 30 Φ), and a suitable amount of whisker was introduced into a side feeder in order to prevent the whisker from being broken by a screw shear force. At this time, the cylinder temperature was adjusted to 150° C. to 210° C., the mixture was kneaded at an extrusion output of 30 kg/hr and a screw rotation number of 250 rpm, and a TOYO (clamping force 180 ton) injection molding apparatus was used, thereby molding a sample.

### Example 2

A polypropylene resin composition was prepared in the same manner as in Example 1, except that a talc having an average diameter of 1.0 μm, which was surface-treated with the organic silane-based coupling agent, and a whisker surface-treated with the organic silane-based coupling agent were mixed at a ratio of about 9 wt %:about 9 wt %.

### Example 3

A polypropylene resin composition was prepared in the same manner as in Example 1, except that a talc having an average diameter of 1.0 μm, which was surface-treated with the organic silane-based coupling agent, and a whisker surface-treated with the organic silane-based coupling agent were mixed at a ratio of about 6 wt %:about 12 wt %.

### Comparative Example 1

A polypropylene resin composition was prepared in the same manner as in Example 1, except that an ethylene-octene random copolymer having an intrinsic viscosity of about 1.5 dl/g, a talc having an average diameter of 8.0 μm, which was not modified, and a whisker, which was not modified, were mixed at a ratio of about 20 wt %:about 12 wt %:about 6 wt %.

### Comparative Example 2

A polypropylene resin composition was prepared in the same manner as in Comparative Example 1, except that a talc having an average diameter of 8.0 μm, which was not modified, and a whisker, which was not modified, were mixed at a ratio of about 9 wt %:about 9 wt %.

### Comparative Example 3

A polypropylene resin composition was prepared in the same manner as in Comparative Example 1, except that a talc having an average diameter of 8.0 μm, which was not modified, and a whisker, which was not modified, were mixed at a ratio of about 6 wt %:about 12 wt %.

TABLE 1

| | | Example | | | Comparative Example | | |
|---|---|---|---|---|---|---|---|
| Configuration (wt %) | | 1 | 2 | 3 | 1 | 2 | 3 |
| Ethylene-propylene block | | 62 | 62 | 62 | 62 | 62 | 62 |
| copolymer | | | | | | | |
| Ethylene-octene | Intrinsic | 20 | 20 | 20 | | | |
| random | viscosity | | | | | | |
| copolymer | 2.5 dl/g | | | | | | |
| | Intrinsic | | | | 20 | 20 | 20 |
| | viscosity | | | | | | |
| | 1.5 dl/g | | | | | | |
| Surface | Talc (1.0 μm) | 12 | 9 | 6 | | | |
| modification O | Whisker | 6 | 9 | 12 | | | |
| Surface | Talc (8.0 μm) | | | | 12 | 9 | 6 |
| modification X | Whisker | | | | 6 | 9 | 12 |

### Test Examples

<Evaluation>

### Test Example 1

### Specific Gravity

The specific gravities of the samples obtained in the Examples and the

Comparative Examples were measured in accordance with ASTM D792, and the results are shown in [Table 2].

### Test Example 2

### Flexural Modulus

The flexural moduli of the samples prepared in the Examples and the Comparative Examples were measured by setting a sample having a size of 12.7×127×6.4 mm at a crosshead speed of 10 mm/min using ASTM D790, and the results are shown in [Table 2].

### Test Example 3

### IZOD Impact Strength

The IZOD impact strengths of the samples obtained in the Examples and the Comparative Examples were measured at room temperature (23° C.) in accordance with ASTM D256, and the results are shown in [Table 2].

### Test Example 4

### Coating Adhesion Force

The distance with the sample was vertically maintained at 10 cm by using a Karcher high-pressure apparatus, high-temperature and high-pressure water at 70° C. and 65 bar was ejected onto the surface of the test sample through a pipe nozzle to evaluate the coating adhesion force by whether damage was caused on the surface of the coating film. At this time, cross-cut marks were made on the surface of the coating film sample, the surface was left to stand for about 24 hours after being coated, and then a test was performed. For the evaluation criteria of adhesion force, the case where there is no peeling-off, the case where about 5% of the surface of the coating film was peeled off, the case where about 5% to about 35% of the surface of the coating film was peeled off, the case where about 35% to about 65% of the surface of the coating film was peeled off, and the case where all of the surface of the coating film was peeled off were marked with “0”, “1”, “2”, “3”, “4”, respectively.

TABLE 2

| | Example | | | Comparative Example | | |
|---|---|---|---|---|---|---|
| Item | 1 | 2 | 3 | 1 | 2 | 3 |
| Specific gravity | 1.01 | 1.00 | 0.99 | 1.01 | 1.00 | 0.99 |
| (g/cm³) | | | | | | |
| Flexural modulus | 2,631 | 2,710 | 2,871 | 2,326 | 2,361 | 2,407 |
| (MPa) | | | | | | |
| IZOD impact | 50 | 45 | 35 | 42 | 35 | 24 |
| strength | or | | | | | |
| (Room | more | | | | | |
| temperature, | | | | | | |
| kJ/cm²) | | | | | | |
| Coating adhesion | 1 | 0 | 1 | 3 | 2 | 3 |
| force | | | | | | |

As shown in [Table 2], it was confirmed that Examples 1 to 3 exhibited a flexural modulus of about 2,500 MPa or more, a high impact strength, and excellent coating adhesion force, while maintaining a low specific gravity.

The disclosure has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. A polypropylene resin composition comprising a base resin, a thermoplastic elastomer, and a modified inorganic filler.

2. The polypropylene resin composition of claim 1, wherein the base resin comprises one polypropylene resin selected from the group consisting of a propylene homopolymer, a copolymer of propylene and an α-olefin monomer having 2 and 4 to 20 carbon atoms, and a combination thereof.

3. The polypropylene resin composition of claim 1, wherein the base resin has a melt index of about 20 g/10 min to about 100 g/10 min measured at a temperature of 230° C. and under a load of 2.16 kg in accordance with ASTM D1238.

4. The polypropylene resin composition of claim 1, wherein the base resin has an isotactic pentad fraction of 0.80 to 0.99 by ¹³C-NMR method.

5. The polypropylene resin composition of claim 1, wherein the polypropylene resin composition comprises the base resin in an amount of 50 wt % to 80 wt %, based on a total weight of the polypropylene resin composition.

6. The polypropylene resin composition of claim 1, wherein the thermoplastic elastomer has an intrinsic viscosity within a range from 2 dl/g to 4 dl/g.

7. The polypropylene resin composition of claim 1, wherein the thermoplastic elastomer comprises one selected from the group consisting of an olefin copolymer of ethylene and an α-olefin having 3 to 12 carbon atoms, a styrene-based copolymer, and a combination thereof.

8. The polypropylene resin composition of claim 1, wherein the thermoplastic elastomer is present in an amount within a range from 24 parts by weight to 44 parts by weight based on 100 parts by weight of the base resin.

9. The polypropylene resin composition of claim 1, wherein the inorganic filler is modified by being surface treated with an organic titanate-based coupling agent, an organic silane-based coupling agent, a modified polyolefin grafted with an unsaturated carboxylic acid or an anhydride thereof, a fatty acid, a fatty acid metal salt, a fatty acid ester, and a combination thereof.

10. The polypropylene resin composition of claim 1, wherein the inorganic filler comprises one selected from the group consisting of talc, whisker, nano clay, and a combination thereof.

11. The polypropylene resin composition of claim 1, wherein the inorganic filler has an average diameter within a range from 0.1 μm to 5 μm.

12. The polypropylene resin composition of claim 1, wherein the inorganic filler is comprised in an amount within a range from 8 part by weight to 41 parts by weight based on 100 parts by weight of the base resin.

13. The polypropylene resin composition of claim 1, further comprising an additive selected from the group consisting of an antioxidant, a processing lubricant, a colorant, and a combination thereof.

14. A molded product comprising an injection object of the polypropylene resin composition according to claim 1.

15. The molded product of claim 14, wherein a flexural modulus in accordance with ASTM D790 is 2,500 MPa or more.

16. An exterior material for an automobile comprising the molded product of claim 14.
